(19) United States
(12) Patent Application Publication
(10) Pub. No.: US 2016/0078845 A1
(43) Pub. Date: Mar. 17, 2016

(54) DISPLAY PANEL AND METHOD OF TRANSMITTING SIGNALS THEREIN

(71) Applicant: AU OPTRONICS CORPORATION, HSIN-CHU (TW)

(72) Inventors: Nan-Ying LIN, HSIN-CHU (TW); Chung-Lin FU, HSIN-CHU (TW); Yu-Hsin TING, HSIN-CHU (TW)

(21) Appl. No.: 14/600,168

(22) Filed: Jan. 20, 2015

(30) Foreign Application Priority Data
Sep. 15, 2014 (TW) 103131774

(51) Int. Cl. G09G 5/18; G09G 3/36

(52) U.S. Cl. CPC G09G 5/18; G09G 3/3674

(57) ABSTRACT

A display panel includes scan lines, data lines and a multiplexer circuit. The data lines interlace with the scan lines. The multiplexer circuit includes switches, in which first terminals of the plurality of switches are electrically coupled to one terminals of the data lines, respectively, and the switches are configured to switch on in response to control signals. The data lines are configured to receive image data signals through the switches during enabling periods of the control signals, and at least two control signals of the control signals are synchronously asserted and have enabling periods that are partially overlapped. A method of transmitting signals in a display panel is also disclosed herein.

### RELATED APPLICATIONS

This application claims priority to Taiwan Patent Application Serial Number 103131774, filed Sep. 15, 2014, which is herein incorporated by reference.

### BACKGROUND

1. Technical Field

The present disclosure relates to a display apparatus. More particularly, the present disclosure relates to a multiplexer circuit in a display panel.

2. Description of Related Art

Typical Liquid Crystal Display (LCD) usually includes a scan driver and a data driver. The scan driver is coupled to multiple scan lines, and each one of the scan lines transmits a scan signal to a transistor in a pixel. The data driver is coupled to multiple data lines, and each one of the data lines transmits a data signal to the transistor in the pixel.

With the increase of requirement for resolution of flat-panel display, persons of ordinary skill in the art also research and develop products of super high resolution, e.g., television having resolution of 4K×2K, flat panel computer having resolution of 2048×1546, etc. In conventional art, in regard to display with higher resolution, image signals usually can be transmitted during a scan period for the scan line, through a multiplexer (MUX) configuration, by integrated circuit chip, such that the image signals are correspondingly transmitted through the multiplexer configuration to the data lines.

However, when the resolution of the display increases, the scan period for the scan line becomes shorter, and thus an operation period of the multiplexer configuration becomes shorter as well. For example, in a full-high-definition (Full HD) display having resolution of 1920×1080, the scan period for each scan line is 8.68 microseconds (μs), and if an 1-to-3 multiplexer configuration is adopted, the period for each data line receiving the image signals through the multiplexer configuration is 1.89 μs. When the resolution increases to 4K×2K, the scan period for each scan line is further decreased to 1.89 μs, and if the 1-to-3 multiplexer configuration is adopted, the period for each data line receiving the image signals through the multiplexer configuration is decreased to 0.45 μs. As a result, the period for each data line receiving the image signals would be too short, and it must cause errors to the image signals received by the data line through the multiplexer configuration, such that the frames on the display is in an abnormal condition.

### SUMMARY

An aspect of the present disclosure is related to a display panel. The display panel includes a plurality of scan lines, a plurality of data lines and a multiplexer circuit. The plurality of data lines interlace with the plurality of scan lines. The multiplexer circuit includes a plurality of switches, in which first terminals of the plurality of switches are electrically coupled to one terminals of the plurality of data lines, respectively, and the plurality of switches are configured to switch on in response to a plurality of control signals. The plurality of data lines are configured to receive a plurality of image data signals through the plurality of switches during enabling periods of the plurality of control signals, and at least two control signals of the plurality of control signals are synchronously asserted and have enabling periods that are partially overlapped.

Another aspect of the present disclosure is related to a method of transmitting signals applied in the display panel mentioned above. The method includes transmitting a plurality of control signals to the plurality of switches corresponding thereto, such that the plurality of switches are configured to switch on according to the plurality of control signals, wherein at least two control signals of the plurality of control signals are synchronously asserted and have enabling periods that are partially overlapped; and transmitting a plurality of image data signals through the plurality of switches to the plurality of data lines, during enabling periods of the plurality of control signals.

Yet another aspect of the present disclosure is related to a display panel. The display panel includes a plurality of scan lines, a plurality of data lines and a multiplexer circuit. The plurality of data lines interlace with the plurality of scan lines. The multiplexer circuit includes a plurality of switches, in which first terminals of the plurality of switches are electrically coupled to one terminals of the plurality of data lines, respectively, and the plurality of switches are configured to switch on in response to a plurality of control signals. The plurality of data lines are configured to receive a plurality of image data signals through the plurality of switches during enabling periods of the plurality of control signals, and at least two control signals of the plurality of control signals are synchronously asserted and have different pulse widths.

Still another aspect of the present disclosure is related to a method of transmitting signals applied in the display panel mentioned above. The method includes transmitting a plurality of control signals to the plurality of switches corresponding thereto, such that the plurality of switches are configured to switch on according to the plurality of control signals, wherein at least two control signals of the plurality of control signals are synchronously asserted and have different pulse widths; and transmitting a plurality of image data signals through the plurality of switches to the plurality of data lines, during enabling periods of the plurality of control signals.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of various embodiments, with reference to the accompanying drawings as follows:

FIG. 1 is a schematic diagram of a display panel according to one embodiment of the present disclosure;

FIG. 2 is a schematic diagram of a portion of the display panel illustrated in FIG. 1, according to one embodiment of the present disclosure;

FIG. 3 is a clock diagram of the signals illustrated in FIG. 2, according to one embodiment of the present disclosure; and

FIG. 4 is a clock diagram of the signals illustrated in FIG. 2, according to various embodiments of the present disclosure.

### DETAILED DESCRIPTION

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

It will be understood that in the present disclosure, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

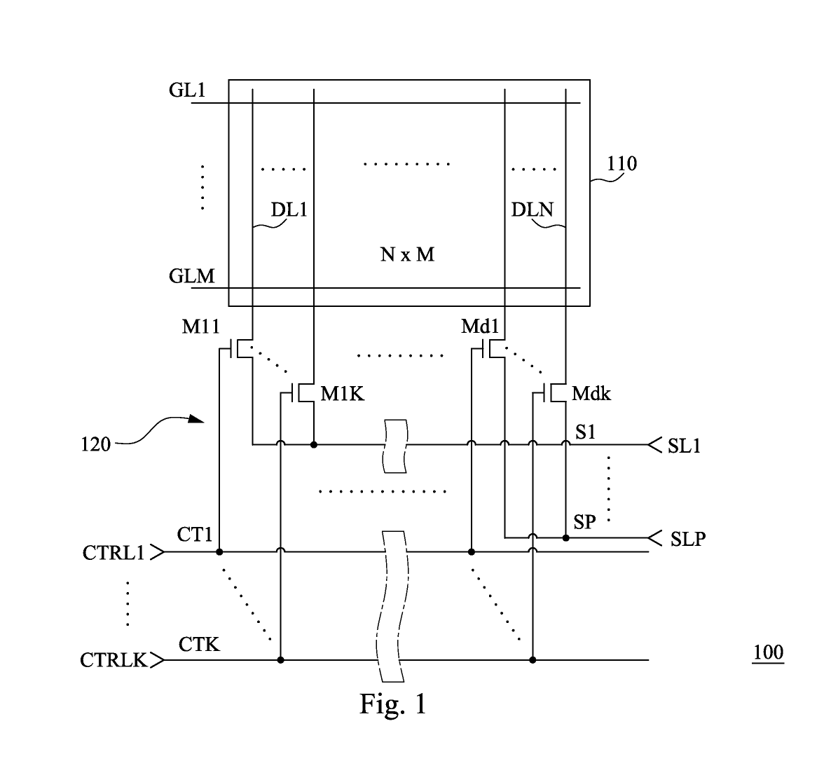

FIG. 1 is a schematic diagram of a display panel according to one embodiment of the present disclosure. As illustrated in FIG. 1, the display panel 100 includes a display array 110 and a multiplexer circuit 120, in which the multiplexer circuit 120 is electrically coupled to the display array 110.

The display array 110 includes a plurality of data lines (e.g., N data lines DL1-DLN, N is a positive integer) and a plurality of scan lines (e.g., M scan lines GL1-GLM, M is a positive integer), and the data lines interlace with the scan lines to form a pixel array. In the present embodiment, the data lines DL1-DLN are electrically coupled to the multiplexer circuit 120, and configured to receive image data signals according to operations of the multiplexer circuit 120.

In addition, the multiplexer circuit 120 includes a plurality of switches, and the switches are electrically coupled to the data lines DL1-DLN, respectively, and configured to switch on in response to a plurality of control signals CTRL1-CTRLK. Specifically, as illustrated in FIG. 1, the multiplexer circuit 120 includes a 1st group of switches M11-M1K, a 2nd group of switches M21-M2K, . . . , and a d-th group of switches Md1-MdK, in which first terminals of the switches M11-M1K, M21-M2K, . . . , Md1-MdK are electrically coupled to one terminals of the data lines DL1-DLN, respectively, where d and K are positive integers.

Moreover, the 1st group of switches M11-M1K are configured to receive the control signals CTRL1-CTRLK, respectively, and controlled by the control signals CTRL1-CTRLK, respectively, to switch on. Similarly, the d-th group of switches Md1-MdK are configured to receive the control signals CTRL1-CTRLK, respectively, and controlled by the control signals CTRL1-CTRLK, respectively, to switch on. Configurations of other groups of switches may be deduced by analogy, and thus they are not further detailed herein.

In practice, each of the switches mentioned in the present disclosure may be an analog switch, a digital switch, a thin-film transistor switch or the other type of switch, the appropriate type of switch can be selected and used by persons of ordinary skill in the art according to practical needs for the design of the multiplexer circuit, and thus the types of the aforementioned switches are not limited. In some embodiments, each of the aforementioned switches may further include a transistor made of InGaZn Oxide (IGZO).

In some embodiments, as illustrated in FIG. 1, the display panel 100 can further include a plurality of control lines CT1-CTL, and the control lines CT1-CTL are configured to transmit the control signals CTRL1-CTRLK, respectively. In addition, the control lines CT1-CTL are electrically coupled to control terminals of the 1st group of switches M11-M1K, respectively, and control terminals of the d-th group of switches Md1-MdK, respectively, and the rest may be deduced by analogy.

Furthermore, during enabling periods of the control signals CTRL1-CTRLK, the data lines DL1-DLN can be configured to receive a plurality of image data signals SL1-SLP through the switches M11-M1K, M21-M2K, . . . , Md1-MdK, where P is a positive integer. Specifically, during the enabling periods of the control signals CTRL1-CTRLK, the switches M11-M1K switch on in response to the control signals CTRL1-CTRLK, respectively, such that the image data signal SL1 is transmitted through the switches M11-M1K to the corresponding data lines, respectively. Similarly, during the enabling periods of the control signals CTRL1-CTRLK, the switches Md1-MdK switch on in response to the control signals CTRL1-CTRLK, respectively, such that the image data signal SLP is transmitted through the switches Md1-MdK to the corresponding data lines, respectively. Operations of other groups of switches may be deduced by analogy, and thus they are not further detailed herein.

In practice, the display panel 100 can be a high-resolution panel, e.g., full HD 1080 panel having high-quality resolution (1920×1080), 4K2K panel having super high resolution (3840×2160), or panel having even higher resolution. In some embodiments, at least one of the enabling periods of the control signals CTRL1-CTRLK can be equal to or smaller than approximately 1.89 microseconds (μs), or equal to or smaller than approximately 0.45 microsecond (μs).

In further embodiments, the display panel 100 can further include a plurality of image signal lines S1-SP, in which the image signal lines S1-SP are configured to transmit the image data signals SL1-SLP, and each one of the image signal lines S1-SP is electrically coupled to one corresponding group of switches. Specifically, the image signal line S1 is electrically coupled to second terminals of the 1st group of switches M11-M1K, the image signal line SP is electrically coupled to second terminals of the d-th group of switches Md1-MdK, and the rest may be deduced by analogy.

On the other hand, when resolution of the panel increases, an operation period of the multiplexer circuit becomes shorter, and thus the period for each data line receiving the image data signals also becomes shorter correspondingly, resulting in that the image data signals received by the data lines through the multiplexer circuit may have errors. In order to avoid this situation, at least two control signals of the control signals CTRL1-CTRLK are synchronously asserted and have enabling periods that are partially overlapped. Specific illustrations are described below.

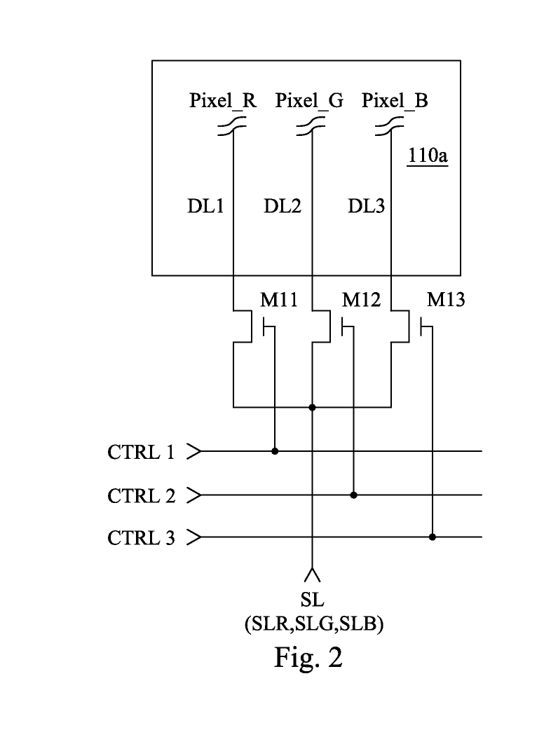

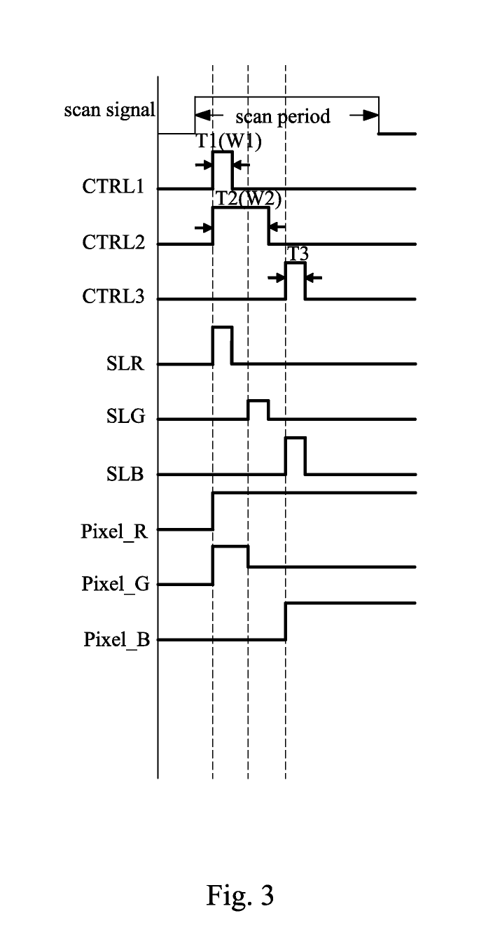

FIG. 2 is a schematic diagram of a portion of the display panel illustrated in FIG. 1, according to one embodiment of the present disclosure. For convenience and clarification of illustration, FIG. 2 merely illustrates a 1-to-3 multiplexer circuit (including switches M11, M12, and M13), and is exemplarily described with corresponding control signals CTRL1-CTRL3, image data signal SL and data lines DL1-DL3, but it is not limiting of the present disclosure. In other words, within the spirit and scope of the appended claims of the present disclosure, one of ordinary skill in the art can apply the concepts of the present disclosure in 1-to-X (X larger than 1) multiplexer circuits and display panels in which the multiplexer circuits are disposed. Moreover, FIG. 3 is a clock diagram of the signals illustrated in FIG. 2, according to one embodiment of the present disclosure. For clarification of illustration, operations mentioned below are exemplarily described with reference to FIG. 2 together with FIG. 3.

As illustrated in FIG. 2 and FIG. 3, the control signals CTRL1-CTRL3 are enabled or generated during a scan period for a single scan line, and the control signals CTRL1 and CTRL2 are synchronously asserted, in which an enabling period T1 of the control signal CTRL1 is partially overlapped with an enabling period T2 of the control signal CTRL2, e.g., the enabling period T2 is longer than the enabling period T1, and an enabling period T3 of the control signal CTRL3 is not overlapped with the enabling periods T1 and T2. In various embodiments, the control signal CTRL1 has a pulse width W1, the control signal CTRL2 has a pulse width W2, and the pulse width W2 is larger than the pulse width W1.

Furthermore, in some embodiments, the switches M11-M13 are disposed, in the multiplexer circuit, corresponding to red, green and blue sub-pixels, respectively. The switches M11-M13 switch on according to the control signals CTRL1-CTRL3, respectively, such that the data lines DL1-DL3 receive, through the switches M11-M13, image data signals SLR, SLG, SLB corresponding to the sub-pixels with different colors, in which the image data signals SLR, SLG, SLB are not overlapped with each other.

In some embodiments, in the condition of performing driving operations associated with pixel column inversion, the image data signals SLR, SLG, SLB have same polarity (e.g., same positive polarity or negative polarity).

In operation, the control signals CTRL1 and CTRL2 are synchronously asserted, such that the switches M11 and M12 synchronously switch on according to the control signals CTRL1 and CTRL2, respectively. At the moment, the image data signals SLR corresponding to the red sub-pixel is transmitted through the switches M11 and M12 to the data lines DL1 and DL2, respectively, such that the data lines DL1 and DL2 are charged to have a voltage level corresponding to the image data signal SLR, and thus the corresponding sub-pixel in the display panel 100a can receive a corresponding data signal Pixel_R transmitted by the data line DL1.

Illustratively, the data line DL2 is also charged according to the image data signal SLR, and thus the data line DL2 can be pre-charged by the aforementioned operation, to reduce transition range and transition time for the data signal, and the problem that an objective pixel voltage in each pixel may have deviations due to an insufficient charging of the data line can be avoided as well.

Afterwards, when the switch M11 switches off according to the control signal CTRL1, the switch M12 still switches on according to the control signal CTRL2 (because the enabling period T2 is longer than the enabling period T1). At the moment, the image data signal SLG corresponding to the green sub-pixel is transmitted through the switch M12 to the data line DL2, such that the data line DL2 is charged to have a voltage level corresponding to the image data signal SLG, and thus the corresponding sub-pixel in the display panel 100a can receive a corresponding data signal Pixel_G transmitted by the data line DL2.

Then, after the switches M11 and M12 switch off, the control signal CTRL3 is asserted, such that the switch M13 switches on according to the control signal CTRL3. At the moment, the image data signal SLB corresponding to the blue sub-pixel is transmitted through the switch M13 to the data line DL3, such that the data line DL3 is charged to have a voltage level corresponding to the image data signal SLB, and thus the corresponding sub-pixel in the display panel 100a can receive a corresponding data signal Pixel_B transmitted by the data line DL3.

As a result, when resolution of the panel is required to increase, by reducing the time interval between two adjacent control signals and increasing the enabling period of the control signal, switch-on durations of the switches in the multiplexer circuit can be increased, so as to solve the problem that the period in which each data line can receive the image data signal becomes short due to a short operation period for the multiplexer circuit can be solved, avoiding the limitation that the charging duration of each data line is insufficient. In addition, the corresponding data lines can be pre-charged according to the image data signals, and thus transition range and transition time for the data signal can be reduced, and the condition that the objective pixel voltage in each pixel may have deviations due to an insufficient charging of the data line can be avoided as well.

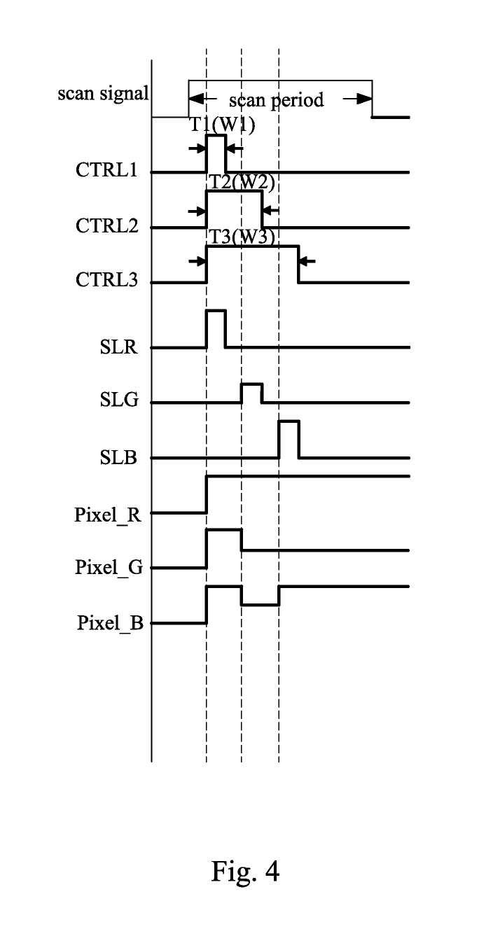

FIG. 4 is a clock diagram of the signals illustrated in FIG. 2, according to various embodiments of the present disclosure. Compared to FIG. 3, the control signal CTRL3 and the control signals CTRL1 and CTRL2 in FIG. 4 are synchronously asserted, in which the enabling period T1 of the control signal CTRL1, the enabling period T2 of the control signal CTRL2 and the enabling period T3 of the control signal CTRL3 are partially overlapped with each other (e.g., the enabling period T3 is longer than the enabling period T1, and the enabling period T2 is longer than the enabling period T1). In various embodiments, compared to FIG. 3, the control signal CTRL3 in FIG. 4 has a pulse width W3, and the pulse widths W1, W2 and W3 are different from each other. For example, the pulse width W3 is larger than the pulse width W2, and the pulse width W2 is larger than the pulse width W1.

In operation, as illustrated in FIG. 2 and FIG. 3, the control signals CTRL1, CTRL2 and CTRL3 are synchronously asserted, such that the switches M11, M12 and M13 switch on synchronously according to the control signals CTRL1, CTRL2 and CTRL3, respectively. At the moment, the image data signals SLR corresponding to the red sub-pixel is transmitted through the switches M11, M12 and M13 to the data lines DL1, DL2 and DL3, respectively, such that the data lines DL1, DL2 and DL3 are charged to have a voltage level corresponding to the image data signal SLR, and thus the corresponding sub-pixel in the display panel 100a can receive the corresponding data signal Pixel_R transmitted by the data line DL1.

Similarly, the data lines DL2 and DL3 are also charged according to the image data signal SLR, and thus the data lines DL2 and DL3 can be pre-charged by the aforementioned operation, to reduce transition range and transition time for the data signal, and the problem that an objective pixel voltage in each pixel may have deviations due to an insufficient charging of the data line can be avoided as well.

Afterwards, when the switch M11 switches off according to the control signal CTRL1, the switches M12 and M13 still switch on according to the control signals CTRL2 and CTRL3 (because the enabling periods T2 and T3 are longer than the enabling period T1). At the moment, the image data signal SLG corresponding to the green sub-pixel is transmitted through the switches M12 and M13 to the data lines DL2 and DL3, respectively, such that the data lines DL2 and DL3 are charged to have a voltage level corresponding to the image data signal SLG, and thus the corresponding sub-pixel in the display panel 100a can receive the corresponding data signal Pixel_G transmitted by the data line DL2.

Then, when the switch M12 switches off according to the control signal CTRL2, the switch M13 still switches on according to the control signal CTRL3 (because the enabling period T3 is longer than the enabling period T2). At the moment, the image data signal SLB corresponding to the blue sub-pixel is transmitted through the switch M13 to the data line DL3, such that the data line DL3 is charged to have a voltage level corresponding to the image data signal SLB, and thus the corresponding sub-pixel in the display panel 100a can receive a corresponding data signal Pixel_B transmitted by the data line DL3.

As a result, the problem that the period in which each data line can receive the image data signal becomes short due to a short operation period for the multiplexer circuit can be solved, and the condition that the objective pixel voltage in each pixel may have deviations due to an insufficient charging of the data line can be avoided as well.

Other some embodiments of the present disclosure are related to a method of transmitting signals, which is applied in the display panel mentioned above. For purposes of illustration, the method of transmitting signals, mentioned below, is exemplarily described with reference to the embodiments illustrated in FIGS. 1-4, but it is not limited to those illustrated in FIGS. 1-4.

The method of transmitting signals includes following operations. First, as illustrated in FIG. 1, the control signals CTRL1-CTRLK are transmitted through the corresponding switches M11-M1K, M21-M2K, . . . , Md1-MdK, such that the switches M11-M1K, M21-M2K, . . . , Md1-MdK switch on according to the control signals CTRL1-CTRLK, in which at least two control signals of the control signals CTRL1-CTRLK are synchronously asserted and have enabling periods that are partially overlapped, or have different pulse widths (as illustrated in FIG. 3). Alternatively, in further embodiments, the control signals CTRL1-CTRLK are synchronously asserted and have enabling periods that are partially overlapped with each other, or have different pulse widths (as illustrated in FIG. 4). Afterwards, as illustrated in FIG. 1, during the enabling periods of the control signals CTRL1-CTRLK, the image data signals SL1-SLP are transmitted through the switches M11-M1K, M21-M2K, . . . , Md1-MdK to the data lines DL1-DLN, respectively.

In some embodiments, in the condition of performing driving operations associated with pixel column inversion, the aforementioned operation of transmitting the image data signals SL1-SLP to the data lines DL1-DLN, respectively, can further include an operation of, in one scan period, transmitting image data signals that have same polarity, through the switches that correspond to red, green and blue sub-pixels, respectively, in the switches M11-M1K, M21-M2K, . . . , Md1-MdK, to the data lines DL1-DLN, respectively.

The operations are not necessarily recited in the sequence in which the steps are performed. That is, unless the sequence of the operations is expressly indicated, the sequence of the operations is interchangeable, and all or part of the operations may be simultaneously, partially simultaneously, or sequentially performed.

As can be known from the aforementioned embodiments of the present disclosure, the display panel mentioned above can be applied such that the problem that the period in which each data line can receive the image data signal becomes short due to increased resolution of the panel can be solved, avoiding the limitation that the charging duration of each data line is insufficient. In addition, the corresponding data lines can be pre-charged, to reduce transition range and transition time for the data signal, and the condition that the objective pixel voltage in each pixel may have deviations due to an insufficient charging of the data line can be avoided as well.

As is understood by one of ordinary skill in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A display panel comprising:
a plurality of scan lines;
a plurality of data lines, the plurality of data lines interlacing with the plurality of scan lines; and
a multiplexer circuit, the multiplexer circuit comprising a plurality of switches, wherein first terminals of the plurality of switches are electrically coupled to one terminals of the plurality of data lines, respectively, and the plurality of switches are configured to switch on in response to a plurality of control signals;
wherein the plurality of data lines are configured to receive a plurality of image data signals through the plurality of switches during enabling periods of the plurality of control signals, and at least two control signals of the plurality of control signals are synchronously asserted and have enabling periods that are partially overlapped.

2. The display panel as claimed in claim 1, wherein the plurality of control signals are synchronously asserted and have enabling periods that are partially overlapped with each other.

3. The display panel as claimed in claim 2, further comprising:
a plurality of image signal lines electrically coupled to second terminals of the plurality of switches, respectively, and configured to transmit the plurality of image data signals.

4. The display panel as claimed in claim 3, wherein in one scan period, one of the plurality of image signal lines is configured to transmit image data signals that correspond to red, green and blue sub-pixels, respectively, and have same polarity, and the image data signals that correspond to red, green and blue sub-pixels are not overlapped with each other.

5. The display panel as claimed in claim 1, further comprising:
a plurality of image signal lines electrically coupled to second terminals of the plurality of switches, respectively, and configured to transmit the plurality of image data signals.

6. The display panel as claimed in claim 5, wherein in one scan period, one of the plurality of image signal lines is configured to transmit image data signals that correspond to red, green and blue sub-pixels, respectively, and have same polarity, and the image data signals that correspond to red, green and blue sub-pixels are not overlapped with each other.

7. The display panel as claimed in claim 2, wherein the display panel is a high-resolution panel, and at least one of the enabling periods of the plurality of control signals transmitted in the high-resolution panel is equal to or smaller than approximately 1.89 microseconds, or equal to or smaller than approximately 0.45 microsecond.

8. The display panel as claimed in claim 1, wherein the display panel is a high-resolution panel, and at least one of the enabling periods of the plurality of control signals transmitted in the high-resolution panel is equal to or smaller than approximately 1.89 microseconds, or equal to or smaller than approximately 0.45 microsecond.

9. A method of transmitting signals applied in the display panel as claimed in claim 1, the method comprising:
transmitting a plurality of control signals to the plurality of switches corresponding thereto, such that the plurality of switches are configured to switch on according to the plurality of control signals, wherein at least two control signals of the plurality of control signals are synchronously asserted and have enabling periods that are partially overlapped; and
transmitting a plurality of image data signals through the plurality of switches to the plurality of data lines, during enabling periods of the plurality of control signals.

10. The method of transmitting signals as claimed in claim 9, wherein the plurality of control signals are synchronously asserted and have enabling periods that are partially overlapped with each other.

11. The method of transmitting signals as claimed in claim 10, wherein transmitting the plurality of image data signals through the plurality of switches to the plurality of data lines, during enabling periods of the plurality of control signals, further comprises:
in one scan period, transmitting image data signals that have same polarity, through switches that correspond to red, green and blue sub-pixels, respectively, in the plurality of switches, to the plurality of data lines.

12. The method of transmitting signals as claimed in claim 9, wherein transmitting the plurality of image data signals through the plurality of switches to the plurality of data lines, during enabling periods of the plurality of control signals, further comprises:
in one scan period, transmitting image data signals that have same polarity, through switches that correspond to red, green and blue sub-pixels, respectively, in the plurality of switches, to the plurality of data lines.

13. A display panel comprising:
a plurality of scan lines;
a plurality of data lines, the plurality of data lines interlacing with the plurality of scan lines; and
a multiplexer circuit, the multiplexer circuit comprising a plurality of switches, wherein first terminals of the plurality of switches are electrically coupled to one terminals of the plurality of data lines, respectively, and the plurality of switches are configured to switch on in response to a plurality of control signals;
wherein the plurality of data lines are configured to receive a plurality of image data signals through the plurality of switches during enabling periods of the plurality of control signals, and at least two control signals of the plurality of control signals are synchronously asserted and have different pulse widths.

14. The display panel as claimed in claim 13, wherein the plurality of control signals are synchronously asserted, and pulse widths of the plurality of control signals are different from each other.

15. The display panel as claimed in claim 14, wherein in one scan period, the plurality of data lines are configured to receive image data signals that have same polarity, through switches that correspond to red, green and blue sub-pixels, respectively, in the plurality of switches.

16. The display panel as claimed in claim 14, wherein the display panel is a high-resolution panel, and at least one of the enabling periods of the plurality of control signals transmitted in the high-resolution panel is equal to or smaller than approximately 1.89 microseconds, or equal to or smaller than approximately 0.45 microsecond.

17. The display panel as claimed in claim 13, wherein in one scan period, the plurality of data lines are configured to receive image data signals that have same polarity, through switches that correspond to red, green and blue sub-pixels, respectively, in the plurality of switches.

18. The display panel as claimed in claim 13, wherein the display panel is a high-resolution panel, and at least one of the enabling periods of the plurality of control signals transmitted in the high-resolution panel is equal to or smaller than approximately 1.89 microseconds, or equal to or smaller than approximately 0.45 microsecond.

19. A method of transmitting signals applied in the display panel as claimed in claim 13, the method comprising:
transmitting a plurality of control signals to the plurality of switches corresponding thereto, such that the plurality of switches are configured to switch on according to the plurality of control signals, wherein at least two control signals of the plurality of control signals are synchronously asserted and have different pulse widths; and
transmitting a plurality of image data signals through the plurality of switches to the plurality of data lines, during enabling periods of the plurality of control signals.

20. The display panel as claimed in claim 19, wherein the plurality of control signals are synchronously asserted, and pulse widths of the plurality of control signals are different from each other.
